(19) United States
(12) Patent Application Publication
(10) Pub. No.: US 2025/0080469 A1
(43) Pub. Date: Mar. 6, 2025

(54) ENTERPRISE-FRIENDLY SCS POLICY VALIDATION

(71) Applicant: Cisco Technology, Inc., San Jose, CA (US)

(72) Inventors: Malcolm M. SMITH, Richardson, TX (US); Brian D. HART, Sunnyvale, CA (US); Venkataprasad CHIRREDDY, Milpitas, CA (US); Sanjay K. KATABATHUNI, Fremont, CA (US); Binita GUPTA, San Diego, CA (US)

(21) Appl. No.: 18/817,876

(22) Filed: Aug. 28, 2024

Related U.S. Application Data
(60) Provisional application No. 63/589,122, filed on Oct. 10, 2023.
(60) Provisional application No. 63/580,241, filed on Sep. 1, 2023.

(51) Int. Cl. H04L 47/2441; H04L 47/2425; H04L 47/2483

(52) U.S. Cl. CPC H04L 47/2441; H04L 47/2433; H04L 47/2483

(57) ABSTRACT

The present disclosure provides techniques for Stream Classification Service (SCS) policy validation for downlink and uplink traffic. A network device receives an SCS request from an associated STA, which specifies one or more sets of TCLAS information for a data flow transmitted between the network device and the STA, each set of TCLAS information being accompanied by associated QoS profile information for the data flow. The network device compares the sets of TCLAS information and associated QoS profile information with one or more cached application profiles, and determines that there is no match. In response to the determination, the network device performs packet analysis and confirms that the sets of TCLAS information and associated QoS profile information align with the type of service of the data flow under defined network polices. In response to the confirmation, the network device applies one or more treatments to the data flow.

### CROSS-REFERENCE TO RELATED APPLICATIONS

This application claims benefit of co-pending U.S. provisional patent application Ser. No. 63/580,241 filed Sep. 1, 2023 and co-pending U.S. provisional patent application Ser. No. 63/589,122, filed Oct. 10, 2023. The aforementioned related patent applications are herein incorporated by reference in their entirety.

### TECHNICAL FIELD

Embodiments presented in this disclosure generally relate to wireless communication. More specifically, embodiments disclosed herein relate to enhanced Stream Classification Service (SCS) policy validation by performing on-demand packet analysis to identify traffic's service types or application classifications and implementing application-specific Quality of Service (QoS) management based on the detected characteristics.

### BACKGROUND

The IEEE 802.11 be/Wi-Fi 7 Stream Classification Service (SCS) feature defines a request/response transaction between the station (STA) or non-access point Multi-Link Device (non-AP MLD) and access point (AP) or AP MLD. This transaction allows the STA to request specific traffic class (TCLAS) treatments for traffic flows identified by a 5-tuple or a class of flows identified by a Differentiated Services Code Point (DSCP) value, mapping these to specific user priority/traffic identifier (UP/TID). In Wi-Fi 7, specifying a TCLAS is allowed for downlink (DL) traffic flows only. The SCS request can be either sent before the corresponding traffic flow starts, through explicit operating system (OS)-stack integration with SCS, or during the flow, through Wi-Fi driver-based flow-detection implicitly triggering SCS. Regardless of the timing, the general expectation is that the wireless local area network (WLAN) or AP applies the requested policy and either responds positively or rejects the request based primarily on WLAN resources, such as TCLAS processing limitations, or application policies that do not allow the request.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example WLAN infrastructure for application-based traffic management in an enterprise setting, according to some embodiments of the present disclosure.

FIG. 2 depicts an example sequence of SCS policy validation using policy pre-check and on-demand packet analysis, according to some embodiments of the present disclosure.

FIG. 3 depicts an example sequence of SCS policy validation with provisional resource allocation, according to some embodiments of the present disclosure.

FIG. 4 depicts an example method for performing application-specific policy validation and on-demand packet analysis for enhanced quality of service (QoS) management, according to some embodiments of the present disclosure.

FIG. 5 is a flow diagram depicting an example method for enhanced SCS policy validation, according to some embodiments of the present disclosure.

FIG. 6 depicts an example network device configured to perform various aspects of the present disclosure, according to some aspects of the present disclosure.

FIG. 7 depicts an example client device configured to perform various aspects of the present disclosure, according to some embodiments of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure provides a method, including receiving, by a network device, a Stream Classification Service (SCS) request from an associated station (STA), where the SCS request specifies one or more sets of traffic class (TCLAS) information for a data flow transmitted between the network device and the STA, each set of TCLAS information being accompanied by associated quality of service (QoS) profile information for the data flow, comparing, by the network device, the one or more sets of TCLAS information and the associated QoS profile information with one or more cached application profiles, determining, by the network device, that the one or more sets of TCLAS information and the associated QoS profile information do not match any of the one or more cached application profiles, performing, in response to the determination, by the network device, packet analysis to determine a type of service of the data flow, confirming, by the network device, that the one or more sets of TCLAS information and the associated QoS profile information align with the determined type of service based on one or more defined network policies, applying, in response to the confirmation, by the network device, one or more treatments to the data flow based on the one or more sets of TCLAS information and the associated QoS profile information received in the SCS request, where the one or more treatments are consistent with at least one of the determined type of service or the one or more defined network policies.

Other embodiments in this disclosure provide one or more non-transitory computer-readable media containing, in any combination, computer program code that, when executed by operation of a computer system, performs operations in accordance with one or more of the above methods, as well as a system of a network device comprising one or more computer processors, and one or more memories collectively containing one or more programs, which, when executed by the one or more computer processors, perform operations in accordance with one or more of the above methods.

### EXAMPLE EMBODIMENTS

With the SCS feature as defined in earlier Wi-Fi standards, the AP receives an SCS request from a client device, which includes the requested TCLAS treatment details. The AP then checks its predefined policies and rules to determine if the requested TCLAS treatments can be supported. This conventional approach relies on static, predefined rules to classify and prioritize traffic based on specific criteria like DSCP values and 5-tuple data (e.g., source IP, destination IP, protocol, source port, and destination port).

However, this conventional SCS method has limitations and cannot accommodate enterprise settings that require application-specific policy validation for requested data flows. In an enterprise setting, QoS policies are not decided solely by the AP. Instead, the policies are managed at a higher network level (e.g., end-to-end (E2E) network-wide policies) and specified based on the application. These network-wide policies ensure that the QoS treatments align with the specific needs of different applications running on the STA.

Since these policies are application-specific, the final decision on QoS treatments to uplink/downlink (UL/DL) traffic specified in the SCS requests primarily depends on the precise identification of the traffic's service type or application classification. The identification may require packet analysis using techniques like Application Visibility and Control (AVC), Deep Packet Inspection (DPI), or Next-Generation Network-Based Application Recognition (NBAR2), which may reside on nodes other than the AP (e.g., wireless local area network (LAN) controller (WLC)). Such packet analysis may take microseconds or milliseconds, making it impractical to provide SCS responses within the very short time frames required for Wi-Fi transactions. Additionally, due to the high computational costs, techniques like DPI may be disabled by default. Consequently, since the SCS response is not provided in time, the client device may unnecessarily time out and retry the SCS request. This prevents the allocation of network resources for the UL/DL flows, resulting in a failure to meet the E2E service level agreement (SLA) set up in the enterprise environments.

Embodiments of the present disclosure introduce techniques that enable application-specific QoS policy validation for UL/DL data flows in enterprise settings. Given the constraints of limited or no negotiation, in one embodiment, the SCS feature may closely integrate with the network policy enforcement function (PEF) along with the in-depth packet analysis capability (e.g., DPI, NBAR2). Within this integration, the packet analysis may be focused on specific validation of the flows requested by the STA. When processing SCS requests, which are requesting treatments for UL/DL traffic corresponding to different applications, the AP may build relevant application profiles. Each application profile may include information such as DSCP values, associated TIDs, 5-tuple data, and other relevant attributes indicating the characteristics of data flows serving the specific application. Upon receiving a new SCS request, the AP may first compare it with the saved application profiles for validation. If a match is found, the AP may directly confirm the request and apply the requested TCLAS (and/or QoS profile) treatments. If no match is found, the AP may perform the in-depth packet analysis (e.g., DPI, NBAR2) on the specified UL/DL packets for a limited period of time (also referred to in some embodiments as a validation time) and conduct further analysis to determine the appropriate QoS treatments.

This approach enables the classification and prioritization of traffic based on application-specific profiles, allowing the applied QoS treatments to align with the specific needs of different applications. Additionally, this approach reduces the computational load by eliminating the need to perform detailed packet analysis on all UL/DL data flows within the WLAN. Instead, within the present disclosure, packet analysis may be implemented only if there are no matched application profiles. Moreover, the packet analysis may target specific flows falling within the validation time frames rather than indiscriminately analyzing all flows or packets, which commonly leads to high computational demands and results in APs disabling the feature. The present disclosure ensures efficient and accurate validation of application-specific QoS policies, and enhances network performance and overall resource allocation.

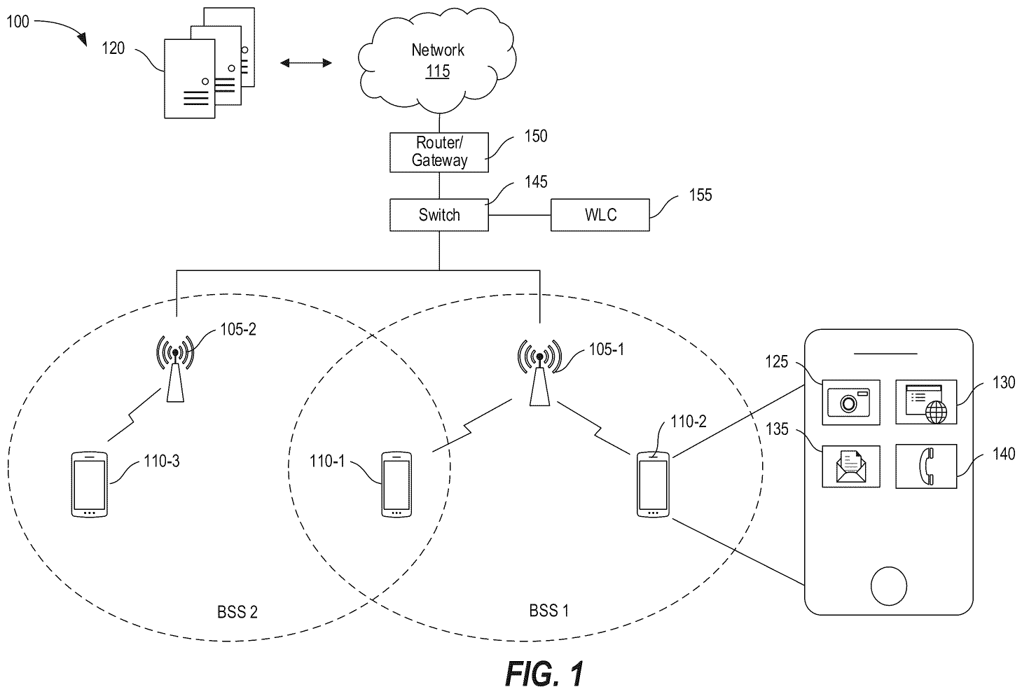

FIG. 1 depicts an example WLAN infrastructure for application-based traffic management in an enterprise setting, according to some embodiments of the present disclosure.

As illustrated, the example WLAN infrastructure 100 comprises multiple BSSs, including BSS 1 and BSS 2. Each BSS consists of an AP 105 connected to multiple station devices (STAs) 110. As depicted in FIG. 1, BSS 1 includes AP 105-1, which connects to STA 110-1 and 110-2, and BSS 2 includes AP 105-2, which connects to STA 110-3.

Both APs 105 are connected to a central network switch 145, which manages UL and/or DL traffic across multiple BSSs. In the uplink transmission, the switch 145 may collect data traffic from both APs 105, and route the traffic to higher network layers through the router (or gateway) 150. In the downlink transmission, the switch 145 distributes incoming traffic from these higher layers to the appropriate APs 105 for delivery to the connected STA 110. The higher network layers establish connections to internal and/or external networks 115, such as the Internet. These networks 115 may connect APs to remote servers 120, which function as the primary sources of various types of data that the STA requests, including, but not limited to, video streaming content, web pages, voice calls, bulk data downloads, and other online services.

As depicted, the switch 145 is also communicatively coupled with a wireless local area network (LAN) controller (WLC) 155, which monitors all APs 105 within the BSSs and manages all wireless data exchanges between the connected STAs 110 and remote servers 120. STAs 110 in the disclosed network setup may include a wide range of computing devices, such as tablets, mobile phones, laptops, or smart home devices. In some embodiments, STAs 110 may also be referred to as client devices or user devices. Each STA 110 may operate multiple applications 125-140, each with specific requirements for UL/DL data. The example WLAN infrastructure 100 enables that data flows smoothly from these remote servers 120, through the AP 105, directly to the STAs 110. This path not only supports the delivery of DL data required by applications running on the STAs, but also facilitates the uploading of UL data that may be transmitted from the STAs 110 back through the AP 105 to the wider network 115.

As depicted in FIG. 1, four applications are installed on the STA 110-2. Application 125 is designed for video conferencing, which typically requires high bandwidth and low latency to maintain video and audio quality. Application 140 handles phone calls, which is similar to video conferencing and requires high bandwidth and prioritization of audio transmission over others. Application 130 supports web browsing, which generally has less stringent QoS demands as compared to real-time communication services like video conferencing or audio calls. Application 135 provides reliable delivery of text messages, which typically requires minimal bandwidth.

In an enterprise setting following the End-to-End Service Level Agreements (E2E SLAs), the QoS policies are not decided solely by the individual APs. Instead, E2E SLA may set up prioritization of applications based on their business criticality, operational requirements, and other relevant factors. For example, in an office setting, applications for day-to-day operations such as audio calls or cloud-based collaboration tools may be prioritized over less important applications like video streaming for entertainment. For applications providing similar services, such as video conferencing tools, E2E SLA may prioritize one application over another based on vendor agreements or company preferences. In such configurations, these QoS policies may be parts of a comprehensive E2E network-wide strategy and designed to meet the specific standards set by the E2E SLA. The policies may be application-specific and/or flow-specific, established to maintain optimal (or at least improved) performance and compliance across the network. Due to the complexity and scope of these policies, individual APs 105 may not be capable of performing policy enforcement on their own. Instead, the WLC 155 may be configured with PEF that enables it to manage and enforce these detailed QoS policies across the entire network infrastructure.

In some embodiments, the STAs 110 may specify traffic class (TCLAS) QoS treatments for upcoming (or in-processing) UL/DL traffic as part of their SCS requests. For example, for DL data for application 125, which is designed for video conferencing, the STA 110-2 may indicate specific requirements in the SCS request, such as a high DSCP value (e.g., “46”) and its associated TID (e.g., “TID 7”) to signal the desired priority levels. The request may further include with 5-tuple data, which consists of the source and destination IP addresses, source and destination ports (e.g., “5004”), and the protocol type (e.g., “User Datagram Protocol (UDP)”), to helps the precise identification of the traffic flows for which the enhanced QoS treatments are being requested. Given these policies are application-specific in an enterprise setting, the WLC 155, configured with PEF, may need to confirm that the requested UL/DL traffic indeed serves an identified application and thus qualifies for the requested treatments. To achieve this, the WLC 155 may implement packet analysis techniques, such as AVC, DPI, and NBAR2, and examine packet payloads to determine the actual service type or application classification of the UL/DL traffic.

Based on the results of the packet analysis, the WLC 155 may perform policy validation to decide whether the traffic indeed matches any existing application profiles and qualifies for the priority level and/or QoS treatments as defined within the enterprise's E2E SLA. However, as discussed above, two issues are presented for the implementation of such application-specific policy validation. First, performing packet analysis like DPI can be time-consuming, taking microseconds or milliseconds, which exceeds the very short time frames required for Wi-Fi transactions. Second, the packet analysis consumes a substantial amount of computational resources, making it infeasible given the current hardware and software capabilities of APs (or WLCs).

To address these concerns and make application-specific policy validation feasible in an enterprise setting, in some embodiments, the WLC 155 may incorporate policy pre-checks and on-demand payload inspections into the policy validation process. Initially, the WLC 155 may perform a policy pre-check when receiving an SCS request from a STA (e.g., 110-2) via its associated AP (e.g., 105-1). During the pre-check stage, the WLC 155 may compare the data included in the SCS request, which indicates the characteristics of the UL/DL traffic, with existing application profiles (e.g., saved by the WLC 155 in its database). In some embodiments, the application profiles may be constructed from previously processed UL/DL traffic for specific applications. These profiles may allow the WLC 155 to quickly identify the nature or classification of incoming traffic based on historical data and manage network resources more efficiently. In some embodiments, the application profiles may include information such as the DSCP, 5-tuple data (e.g., source IP, destination IP, source port, destination port, protocol), TID mappings, and other metrics that can serve as reliable indicators specific to each application (e.g., period, start-time, burst-size, and inter-arrival-time range). For example, the profile for application 125 (providing video conferencing service) may include a typical DSCP value of “46” and its associated TIDs of “6” or “7”, reflecting the high-priority treatment and low-latency requirements. The profile may further include specific source and destination IP addresses, identify “UDP” as the protocol and source and/or destination ports of “5004.” These parameters may be used to verify whether the traffic flows are serving the application 125. Additionally, the profile may include additional indicators such as an inter-arrival-time range of 20 ms, which is typical for video conferencing data that requires consistent packet delivery to maintain video quality. Similarly, profiles for application 130 (providing web browsing service), application 135 (providing text messaging service), and application 140 (providing phone calls) may capture the unique characteristics and requirements of each application, such as lower DSCP values and associated TIDs for applications 130 and 135, and specific protocols and ports commonly used by these applications. In some embodiments, the application profile may include QoS Access Control Lists (ACLs) that are discovered and auto-created by the PEF.

If the policy pre-check indicates a match with a known profile, the WLC 155 may directly approve the request based on pre-validated policies without the need for extensive packet analysis. This efficient validation provides optimized resource allocation and ensures that service quality for known applications is maintained without unnecessary delays. If no match is found during the initial policy check, suggesting a potential policy violation or a new type of application traffic (e.g., beyond the current applications 125-140), the WLC 155 may then proceed to perform on-demand packet analysis (e.g., DPI, NBAR2). This operation may involve a more detailed inspection of the UL/DL packet contents to determine the exact nature or application classification of the traffic. The on-demand analysis allows the WLC 155 to dynamically assess whether the unclassified traffic can be aligned with any policy rules and/or updated application profiles, or if it should be treated as a potential threat or non-compliance issue.

The dual-layered approach of combining policy pre-check with the capability for on-demand analysis makes policy validation per application or traffic flow (as required in enterprise settings) both feasible and efficient. The method significantly reduces response time to align with the stringent time constraints of Wi-Fi transactions. Moreover, by allocating packet analysis tasks only when necessary (e.g., no match with existing application profiles), the method avoids excessive consumption of computation power, making the process compatible with the current hardware and software capabilities of the WLC 155 (or APs 105).

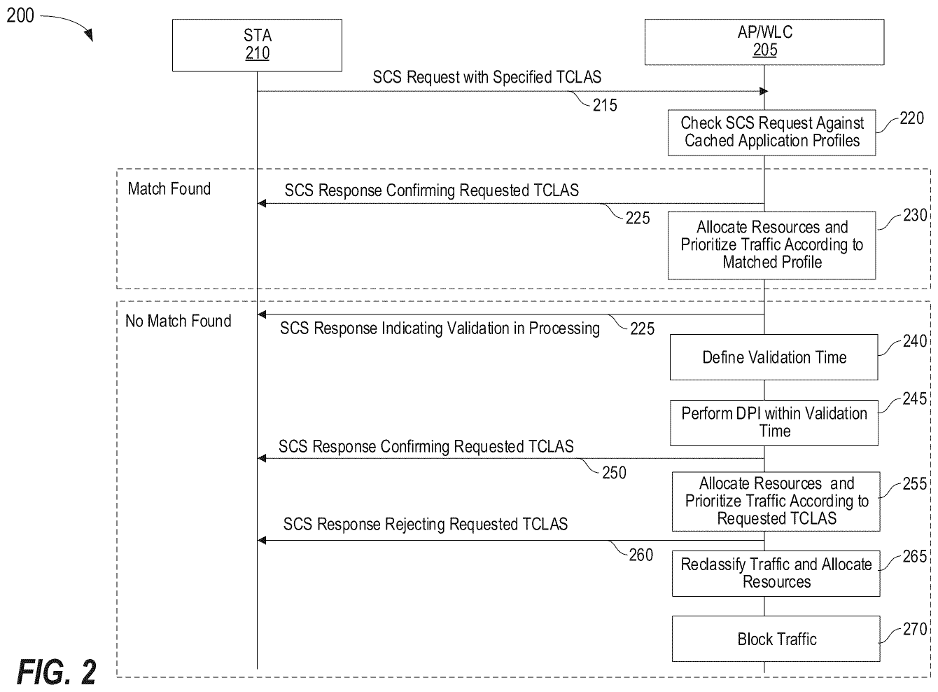

FIG. 2 depicts an example sequence 200 of SCS policy validation using policy pre-check and on-demand packet analysis, according to some embodiments of the present disclosure. In some embodiments, the STA 210 may correspond to the STA 110 as depicted in FIG. 1. In some embodiments, the entity 205 receiving the SCS request and performing policy checks and packet analysis may be a variety of network devices configured with PEF. The entity 205 may correspond to the AP 105 and/or the WLC 155 as depicted in FIG. 1, or any other specialized network devices designed to handle such policy enforcement functions.

As illustrated, the STA 210 first sends an SCS request to the AP/WLC 205 (step 215). The SCS request may include TCLAS information indicating the service type and desired priority of certain UL/DL data flows. The SCS request may be sent either before the traffic arrives or concurrently while the traffic is actively being processed. The information may suggest the desired treatments to satisfy QoS requirements set in the E2E SLA. In some embodiments, the request may specify parameters like DSCP values and desired TIDs for prioritizing traffic within the network. In some embodiments, the request may further include 5-tuple data (e.g., source IP, destination IP, source port, destination port, and protocol), which helps in defining the flow characteristics relevant for maintaining specific service levels. In some embodiments, metadata such as mandatory traffic period, start-time, burst-size, and inter-arrival-time range may also be included within the SCS request to further identify the type and nature of the data. In embodiments where the same DSCP value (or TID) may be used by multiple applications for similar services (e.g., both video streaming and video conferencing applications use DSCP “46” for expedited forwarding), and IP tuples may change over time, additional identifiers such as an application ID or fully qualified domain name (FQDN)/URL may be included within the SCS request. These additional identifiers may help the AP/WLC 205 to ascertain the application classification of the UL/DL traffic more precisely and efficiently.

For an application serving video conferencing (e.g., application 125 of FIG. 1), an example SCS request may include a DSCP value of “46” and desired TID mapping of “7” for high priority, the 5-tuple data (including destination IP address “192.168.1.50,” source IP address “192.168.1.100,” protocol “UDP,” source port “5004,” and destination port “5004”), a specific URL that identifies the conferencing service (e.g., “conference.example.com”), and the metadata to support real-time interaction (e.g., mandatory traffic period of “20 ms,” start time of “0 ms,” burst-size of “50,000 bytes,” and inter-arrival-time range of “20 ms”).

Upon receiving the SCS request, the AP/WLC 205 processes the provided information within the request, and compares the information with its cached application profiles (step 220). In some embodiments, the profiles may contain pre-stored data characterizing typical network usage patterns of recognized applications, including their DSCP values, associated TIDs, source and destination ports, protocol types, application signatures, and other QoS parameters. If the SCS request matches a known application profile, the AP/WLC 205 may identify the upcoming (or in-processing) UL/DL traffic as belonging to a recognized application (e.g., application 125 of FIG. 1) with established QoS settings.

Based on this match, the AP/WLC 205 promptly sends a response back to the STA 210 (step 225). In some embodiments, the response may confirm that the requested TCLAS treatments align with the recognized application profile, and promise that the UL/DL traffic will be handled according to the specific requirements to ensure the expected level of service quality (e.g., defined in E2E SLA within the enterprise environment).

Subsequent to sending the confirmation (or, in some embodiments, concurrently), the AP/WLC 205 proceeds to allocate the relevant network resources and/or prioritize the UL/DL traffic in network queues according to the matched application profile (step 230). These operations may be implemented to ensure that UL/DL traffic flows for known applications (e.g., application 125 of FIG. 1) receive the bandwidth and processing priority as defined by the network policies.

When no match is found during the initial policy check, this indicates a need to perform in-depth packet analysis to determine the specific characteristics and requirements of the UL/DL traffic. In such a configuration, the AP/WLC 205 sends an SCS response to the STA 210 (step 235). This response informs the STA 210 that the SCS validation is currently in processing, and a final decision has not yet been made. In some embodiments, the SCS response may include an indicator of “SCS Processing,” and an estimated timeframes for the validation process (e.g., 200 ms), which helps the STA 210 to anticipate how long it might have to wait for the allocated resources to be applied. Following this, the AP/WLC 210 defines a validation time for the on-demand packet analysis (step 240). The validation time is set to conserve computational resources, avoiding the application of packet analysis (e.g., DPI, NBAR2) to all UL/DL packets being processed by the AP/WLC. With this validation time established, packet analysis is specifically applied to only a limited amount of UL/DL packets failing within the predefined time frame. In some embodiments, the validation time may be determined to balance the need for thorough packet examination with the application's tolerance for delay, particularly for real-time applications like voice or video conferencing. For example, a typical validation time for these applications may be around 200 ms, which is generally sufficient to perform effective PEF without adversely impacting the service quality.

In some embodiments, the validation time may be determined based on data included within the QoS Characteristics Information Element (IE), such as the mandatory traffic period, inter-arrival-time range, and optional start-time. For example, for video conferencing data characterized by an inter-arrival-time range of 20 ms, the validation time may be defined to observe N period (e.g., where N is set to 10, resulting in a total of 200 ms). This period allows the AP/WLC 205 to capture enough data packets to make an informed decision regarding the traffic's nature and/or application classification.

In some embodiments, the SCS response at step 235, which indicates that the SCS validation is pending (e.g., status of “SCS Processing”), may be sent only when the defined validation time is expected to exceed the time an application can reasonably tolerate (potentially leading to service degradation). In such a configuration, the AP/WLC 205 may proactively communicate with the STA 210 and provide an expected time to resolution (e.g., 250 ms). By informing the STA 210 of the delay, the AP/WLC 205 may maintain a stable and reliable connection with the STA 210, even when extensive packet analysis is required.

Following the definition of the validation time, the AP/WLC 205 performs packet analysis like DPI or NBAR2 on the UL/DL packets it receives and/or sends within this specified time frame (step 245). In some embodiments, packet analysis like DPI may involve an in-depth examination of the data payload of the packets. Such examination may allow the AP/WLC 205 to extract and analyze various metrics that can be used for identifying the actual type of service or application classification of the UL/DL traffic. These metrics may include, but are not limited to, media formats, application signatures (e.g., URL or application ID), and protocol-specific data that may indicate the type of application being used (e.g., real-time transport protocol (RTP) for real-time applications or HTTPS for secure web traffic).

In some embodiments, packet analysis like DPI may extend to analyzing SCS metadata such as packet frequency, burst patterns, and inter-arrival times to determine traffic behavioral patterns. The AP/WLC 205 may then use the detected patterns to distinguish different types of traffic (e.g., differentiating interactive video from bulk data transfers). In some embodiments, DPI may involve inspection across layers 4-7 (including transport layer, session layer, presentation layer and application layer), including domain name system (DNS) or FQDN/URL validation. In some embodiments, DPI may be extended to include analysis across layers 2 and 3 (including data link layer and network layer), which further broadens the scope of traffic analysis and enforcement capabilities.

If, with the identified type of service, the AP/WLC evaluates whether the unclassified traffic aligns with any updated or newly recognized application profiles, or if, despite not matching any existing profiles, the type of service aligns with the TCLAS information and is permissible under certain network policies. An example of a permissible non-matching embodiment may include a situation where the TCLAS information within an SCS request includes a DSCP of “46” and an associated TID of “7,” indicating high-priority demands, but the 5-tuple data or other identifiers do not exactly match any existing profiles. Through the DPI, the traffic is identified as being for video conferencing. In this configuration, the WLC may confirm the requested TCLAS (and/or QoS profile) treatments (e.g., TID 7) are allowable based on general policies that maps video conferencing traffic to high-priority level, even if specific details slightly differ from those in any existing profiles. In some embodiments, the AP/WLC 205 may update the cached application profiles to include this new application type. This update facilitates more efficient and quicker processing of similar SCS requests in the future.

Based on the packet analysis results, if the traffic is compliant, the AP/WLC 205 sends a positive SCS response to the STA 210 (step 250). The SCS response may include an indicator of “SUCCESS,” confirming that the requested TCLAS (and/or QoS profile) treatments are justified and aligns with recognized profiles or being acceptable under current network policies. Subsequent to or concurrently sending the SCS response, the AP/WLC 205 allocates the required network resources and/or prioritizes the traffic in network queues according to the requested TCLAS (and/or QoS profile) treatments (step 255). If there is a policy violation, such as traffic from a known application that is not allowed, or unclassified traffic that does not meet any policy criteria, the AP/WLC 205 sends an SCS response to the STA 210, rejecting the requested TCLAS (and/or QoS profile) treatments (step 260). Following that, in some embodiments, the AP/WLC 205 may reclassify the UL/DL traffic to a new priority level, typically lower than the one originally requested. The AP/WLC 205 may then allocate resources and/or prioritize the traffic according to the new priority level (step 265). The reclassification may be based on the identified type of service through DPI. For example, if the desired TID mapping in the SCS request indicates a high priority (e.g., TID 7), but the DPI identifies the traffic as web browsing (a less important service) (e.g., TID 3), the AP/WLC 205 may reclassify it to a lower priority. In some embodiments, after the reclassification, the AP/WLC 205 may send an additional SCS response to the STA 210. This SCS response may indicate the new priority level (e.g., TID 3) and confirm that the corresponding TCLAS (and/or QoS profile) treatments have been assigned to the data flow.

In embodiments where the packet analysis identified the traffic as posting a security risk, the AP/WLC 205 may block the traffic entirely or significantly limit its transmission pending further security checks (step 270). The operation provides that only safe and compliant traffic is allowed to flow via the AP/WLC 205, effectively maintaining the integrity and security of the network.

In some embodiments, the SCS responses 225 and 245 confirming the original TCLAS (and/or QoS profile) treatments may be sent after the resource allocation process. The response may inform STA 210 that the UL/DL traffic has been handled to the confirmed prioritization and resource settings. In some embodiments, the SCS response 255 rejecting the original TCLAS (and/or QoS profile) treatments may be sent after the resource allocation process. The response may inform STA 210 that the UL/DL traffic has been processed according to a new priority level, with adjusted prioritization and resource settings.

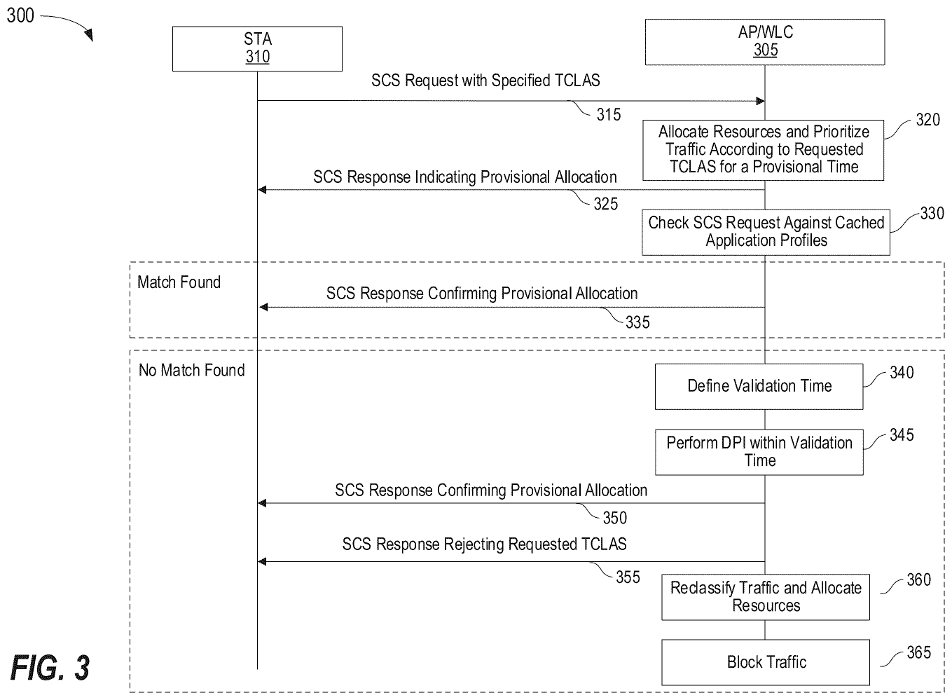

FIG. 3 depicts an example sequence 300 of SCS policy validation with provisional resource allocation, according to some embodiments of the present disclosure. In some embodiments, the STA 310 may correspond to the STA 110 as depicted in FIG. 1. In some embodiments, the entity 305 receiving the SCS request and performing policy checks and packet analysis may be a variety of network devices configured with PEF. The entity 305 may correspond to the AP 105 or the WLC 155 as depicted in FIG. 1, or any other specialized network devices designed to handle such policy enforcement functions.

As depicted, the STA 310 initiates the process by sending an SCS request to the AP/WLC 305 (step 315). As discussed in FIG. 2, the SCS request may include detailed data indicating the type of service or the priority of the upcoming (or in-processing) UL/DL traffic received and/or sent by the AP/WLC 305. Specifically, in some embodiments, the SCS request may include the DSCP value and its associated TID to signal desired QoS levels, as well as 5-tuple data to identify and classify the traffic.

Upon receiving the SCS request, the AP/WLC 305 provisionally allocates network resources and prioritizes traffic based on the TCLAS information within the request (step 320). The provisional allocation is designed to continue until the initial policy pre-check and/or on-demand packet analysis are completed. The provisional allocation is implemented to ensure that traffic specified in the SCS request receives temporary but immediate prioritization and resource support, even before its actual type or application classification is confirmed through the policy pre-check or packet analysis.

This approach may reduce disruptions to service quality and maintain network performance, practically for time-sensitive applications.

For an application providing video conferencing service (e.g., application 125 of FIG. 1), the SCS request may indicate a DSCP of “46” and desired TID mapping of “7,” which are typically reserved for high-priority voice and video traffic. Based on the TID, the AP/WLC 305 then allocates appropriate bandwidth and processing resources to ensure that the traffic specified in the SCS request is handled with the necessary priority and quality.

Subsequent to the provisional resource allocation (or, in some embodiments, concurrently), the AP/WLC 305 sends an initial SCS response to the STA 310 (step 325), indicating the status of “SCS Processing” and confirms that the provisional allocation has been completed but is subject to further adjustment pending the outcome of additional analysis.

Following the provisional resource allocation, the AP/WLC 305 initiates the policy pre-check by comparing information within the SCS request against cached application profiles (step 330). If a match is found with a cached profile, suggesting the UL/DL traffic corresponds to a known application, the AP/WLC 305 sends a second SCS response to the STA 310 (step 335). In some embodiments, the second SCS response may confirm the provisional allocation, and indicate that the provisional status will be changed to permanent based on the established compatibility with known profiles.

If no match with existing application profiles is found, the AP/WLC 305 proceeds to perform the on-demand packet analysis. As depicted, the AP/WLC 305 first defines a validation time during which detailed packet analysis is conducted (step 340). Following that, the AP/WLC 305 performs packet analysis like DPI within the predefined time frame to ascertain the actual nature or classification of the UL/DL traffic (step 345). If the UL/DL traffic aligns with updated application profiles, or if no exact match is found but the traffic type is permissible for requested TCLAS (and/or QoS profile) treatments under certain general network policies, the AP/WLC 305 sends a second response to the STA 310 (step 350), confirming that the provisional allocation will continue.

If there is a policy violation, such as traffic from a known application that is not allowed, or traffic that does not meet any policy criteria, the AP/WLC 305 sends a second SCS response to the STA 310 (step 355), indicating the original TCLAS (and/or QoS profile) treatments specified in the SCS request are rejected. Subsequent to or concurrently sending the second response, the AP/WLC 305 reclassifies the traffic to a new policy level, which aligns with the identified type of service through DPI and is typically lower than the one originally requested. The AP/WLC 305 may then allocate resources and prioritize traffic based on the new priority level (step 360). In embodiments where security risks are identified during the packet analysis, the AP/WLC 305 may choose to block the traffic entirely or significantly limit its transmissions pending further security checks (step 365).

In some embodiments, the AP/WLC 305 may not rely on received SCS requests to trigger the policy validation and on-demand packet analysis. Instead, the AP/WLC may proactively examine the UL/DL packets it receives and/or transmits across the network. The ongoing examination enables the AP/WLC 305 to compare in-processing packet flows against cached application profiles and/or predefined policy rules, and therefore determine each flow's appropriate priority level. Following the analysis, the AP/WLC 305 may then allocate the relevant network resources and prioritize the traffic accordingly. The method of proactive and continuous packet monitoring and analysis helps to maintain effective management of all traffic based on real-time conditions and compliance with established network standards. Although this approach may not specifically save computational resources (e.g., due to the continuous examination), it is simpler to implement in current WLAN systems.

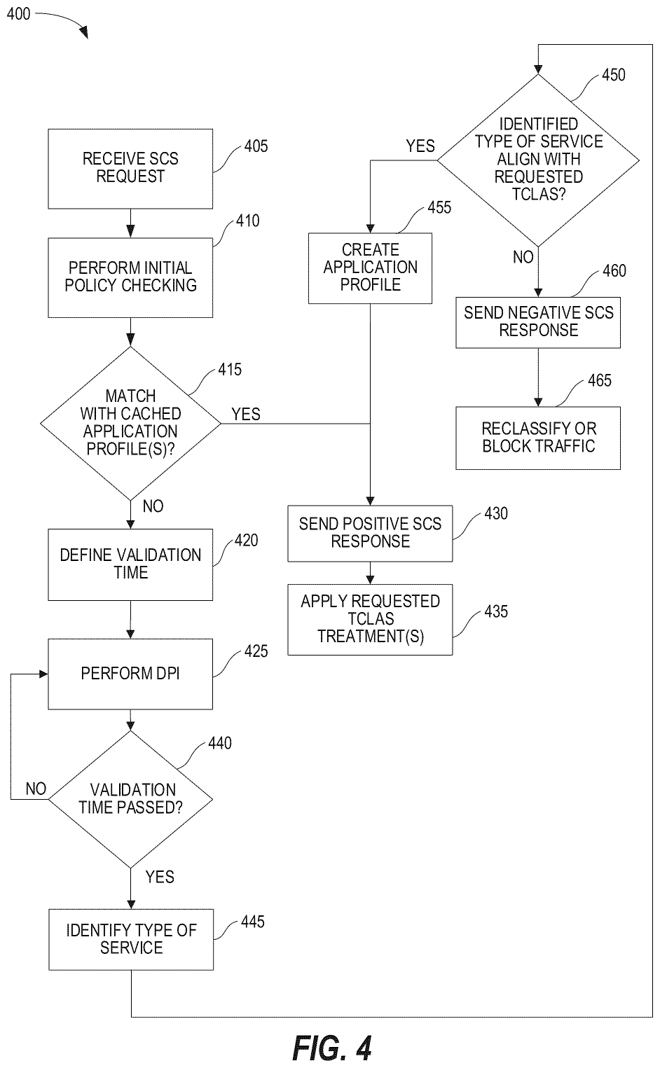

FIG. 4 depicts an example method 400 for performing policy validation and on-demand packet analysis for enhanced QoS management, according to some embodiments of the present disclosure. In some embodiments, the method 400 may be performed by one or more network devices that possess the necessary capabilities for policy validation and packet analysis, such as WLCs 155 and/or APs 105 as depicted in FIG. 1, AP/WLC 205 as depicted in FIG. 2, and AP/WLC 305 as depicted in FIG. 3.

At block 405, a WLC (or AP) (e.g., 155 of FIG. 1) receives an SCS request from an associated STA (e.g., 110-2 of FIG. 1). The SCS request serves to communicate how upcoming or ongoing UL/DL traffic should be managed to meet predefined QoS standards. In some embodiments, the SCS request may include TCLAS information that indicates the characteristics of the data and the desired priority level. The information may include, but is not limited to, a DSCP value with its desired TID mapping, 5-tuple data (e.g., source IP, destination IP, protocol, source port, destination port), and/or application identifier (e.g., an application ID or FQDN/URL). In some embodiments, metadata such as mandatory traffic period, start-time, burst-size, and inter-arrival-time range may also be included to further characterize the traffic's specific requirements.

At block 410, the WLC (or AP) compares the details provided in the SCS request against cached application profiles. In some embodiments, these profiles may include predefined settings and characteristics for known applications and services that have been previously analyzed and validated. The initial policy check may quickly match incoming (or in-processing) UL/DL traffic to established application-specific policies without the need to perform real-time and extensive packet analysis (e.g., DPI, NBAR2) for every request. In some embodiments, the profile for a known application may include specific DSCP values and/or TIDs that correspond to the priority levels appropriate for the application's traffic, as well as pre-defined IP addresses, ports, and protocols commonly used by the application. In some embodiments, the profile may further include application IDs, URLs, or other signatures that uniquely identify an application. In some embodiments, detailed parameters that indicate the application's typical traffic patterns, such as burst sizes, traffic periods, and inter-arrival times, may be included within the profile to provide additional references for precise application classification and policy enforcement for upcoming (or ongoing) UL/DL traffic.

At block 415, the WLC determine if there is a match between the SCS request and cached application profiles. For example, if the SCS request includes a DSCP value of 46, a desired TID mapping of “7,” a protocol like “UDP,” and a port number of “4006,” which aligns with a profile for a video conferencing application (e.g., Webex). This matching information indicates that the traffic belongs to the recognized application and is qualified for high-priority handling.

If such a match is found, the method 400 proceeds to block 430, where the WLC sends a positive SCS response to the STA. The response may indicate that the network has acknowledged the traffic type and priority level indicated in the SCS request and is prepared to manage the specified UL/DL traffic based on the acknowledgment.

Following the approval, at block 435, the WLC manages the traffic according to the pre-established rules and configurations in the profile. In the above example, where traffic has been identified as belonging to a high-priority video conferencing application, the WLC may apply appropriate QoS treatments, including prioritizing the traffic in network queues and allocating sufficient bandwidth to maintain the quality of the video conference.

If no match is found during the initial policy check, suggesting that the specified UL/DL traffic may correspond to an unknown application, at block 420, the WLC sets a validation time specifically for on-demand packet analysis (e.g., DPI, NBAR2). The validation time serves to narrow the scope of packet analysis to the most relevant packets, which thus saves the network's computational resources. In some embodiments, the duration of the validation time may be determined based on QoS characteristics of the traffic, such as the mandatory traffic period, inter-arrival-time range, and optional start-time use, and set to ensure thorough examination while avoiding excessive delays that could degrade service quality. For an application providing real-time video conferencing service (e.g., application 125 of FIG. 1), where the video data arrives every 20 ms, the WLC may set the validation time to observe 10 consecutive packets, resulting in a total observation period of 200 ms. This duration may allow comprehensive packet analysis without adversely impacting the service quality.

In some embodiments, particularly when the defined validation time is excessive, potentially exceeding the time that the application or STA may reasonably tolerate and risking service degradation, the WLC may send an additional SCS response to the STA. This response may indicate that the SCS validation process is still ongoing, and provide an expected time to completion (e.g., 250 ms). This communication helps to manage the STA's expectations, maintaining a stable connection when extended analysis is needed.

At block 425, the WLC performs detailed packet analysis on the UL/DL traffic that falls within the defined validation time to determine its nature, type, or application classification. Techniques such as DPI and NBAR2 may be utilized to examine the payload of the packets. Through DPI or NRAR2, the WLC may look for data formats, application signatures (e.g., FQDN/URL or application ID), protocol use (e.g., “RTP” or “HTTPS”), and other identifiers that indicate the application or service type. The WLC may perform behavioral analysis by processing metadata such as packet frequency, burst patterns, and inter-arrival times. This analysis may help to distinguish between different types of traffic, such as video streaming and web browsing traffic, each having distinct data flow characteristics.

At block 440, the WLC monitors whether the defined validation time has expired. If the validation time has passed, the method 400 moves to block 445. If not, the method 400 returns to block 425, where the WLC continues the packet analysis until the validation period concludes.

At block 445, the WLC identifies the type of service of the UL/DL data flows being handled based on the results of the packet analysis. This identification ensures that the network treats the traffic appropriately according to its actual characteristics, rather than merely its requested classification. For example, suppose the SCS includes a DSCP of “46” with its desired TID mapping of “7,” which is typically reserved for real-time applications such as video conferencing that require high priority and low latency. However, after the detailed packet analysis performed during the validation period, it is determined that the traffic being handled is actually for bulk data downloads. This type of traffic typically does not require high priority, as indicated by the desired TID of “7.” Therefore, in this configuration, the traffic does not qualify for the priority level as stated in the SCS request under general QoS policies. The WLC may reclassify the traffic to a lower priority to ensure fair bandwidth distribution and network efficiency.

At block 450, with the identified service type through packet analysis, the WLC evaluates whether the traffic aligns with any updated or newly recognized application profiles, or if, despite not matching any existing profiles, the type of service aligns with the TCLAS information specified in the SCS request. This alignment indicates that the traffic being handled qualifies for the priority level as stated in the SCS request under certain network policies. For example, suppose the SCS includes a DSCP of “46” with its desired TID mapping of “7,” typically reserved for high-priority real-time applications. The packet analysis reveals that the traffic is for a video streaming service that is not yet profiled but shows characteristics similar to those of other high-priority services. While this traffic does not match any existing cached profiles, its characteristics (e.g., consistent data rates and inter-arrival time, minimal jitter) align with the network's general policies for high-priority traffic handling. In this configuration, even though there is no direct profile match, the WLC may decide that the traffic is permissible and allocate network resources accordingly.

If a positive alignment is confirmed, the method 400 proceeds to block 455, where the WLC updates or creates new profiles to include the new application type. The updates allow quicker approval for similar future SCS requests in the policy pre-check stage. After that, the method 400 moves to blocks 430 and 435, where the WLC sends a positive response confirming the alignment, and applies the requested QoS treatments to UL/DL data flows.

If the traffic does not align with any profiles and the type of service does not align with the TCLAS information specified in the SCS request, therefore not permissible by policy criteria (e.g., the SCS request indicates a DSCP of “46” with its desired TID mapping of “7,” requesting high priority, but the actual service type is for bulk data downloads), the method 400 proceeds to block 460. At block 460, the WLC sends a negative response to the STA, indicating the rejection of the requested TCLAS (and/or QoS profile) treatments.

At block 465, the WLC reclassifies the UL/DL traffic to a lower priority that is compatible with the traffic's determined service type. In embodiments where packet analysis reveals security risks or threats, the WCL may block or significantly restrict the transmission of the UL/DL traffic pending further security checks.

The example method 400 is provided for conceptual clarity. In some embodiments, the WLC may provisionally assign resources to the upcoming (or ongoing) UL/DL traffic once the SCS request is received, without waiting for the completion of the initial policy pre-check. In such a configuration, an initial SCS response may be sent to the STA, indicating that the SCS validation is in process and that the resource allocation and traffic treatment are temporary, and will be confirmed or adjusted based on further analysis. The initial SCS response informs the STA that changes to the treatment of its traffic may still occur. Following sending the initial SCS response, the WLC proceeds to perform the policy pre-check. If the pre-check reveals a match with existing application profiles, the WCL sends a second SCS response to the STA, confirming the continuation of the provisional resource allocation until the transmission is completed. The positive response indicates that the initially assigned resources and treatments are appropriate and will be maintained. In embodiments where no match is found, the WLC may proceed to perform detailed packet analysis (e.g., DPI, NBAR2) to identify the nature or actual service type of the traffic. If the packet analysis determines that the type of service of the traffic aligns with the TCLAS information specified in the SCS request and is permissible under general network policies, the WLC sends a second SCS response to the STA, confirming the continuation of the provisional resource allocation until the end of the transmission. The positive response suggests that the traffic, while initially unprofiled, meets the policy criteria for the requested priority. If the packet analysis reveals a misalignment between the actual service type and the requested treatment, suggesting that the traffic does not qualify for the priority level as stated in the SCS request, the WCL sends a second response to the STA, rejecting the requested treatment. The WLC may then reclassify the traffic to a lower priority, aligning with the traffic's actual service type, or block the traffic if there are security threats.

In some embodiments, the WLC may not wait for SCS requests to initiate the policy pre-check or on-demand packet analysis. Instead, the WLC may continue to monitor and evaluate every UL/DL data flow it handles. The WLC may then apply dynamic resource allocation and prioritization treatments based on real-time assessments. As part of the continuous traffic management, the WLC may compare packet flows against cached application profiles. These profiles may contain detailed characteristics of known applications, including DSCP values and preferred TIDs, typical 5-tuple configurations, and expected traffic patterns such as burst sizes and inter-arrival times. As each packet arrives, the WCL may assess its metadata to see if the packet aligns with any existing profiles. If a match is found, the WLC may quickly apply the correct QoS settings to manage known traffic types. For packets that do not match any existing profiles, the WLC may proceed to conduct detailed packet analysis to determine the nature of the traffic. This may involve in-depth inspection using DPI or NBAR2 techniques to examine the payload of each packet and find underlying application signatures, data formats, and behavioral patterns. Based on the analysis, the WLC may decide the appropriate priority and resource allocation for the traffic. The proactive and continuous evaluation allows the WLC to adapt efficiently to changes in network conditions and traffic types. By not relying on SCS requests, the WCL maintains a high level of network control and preemptively manages resources to prevent congestion.

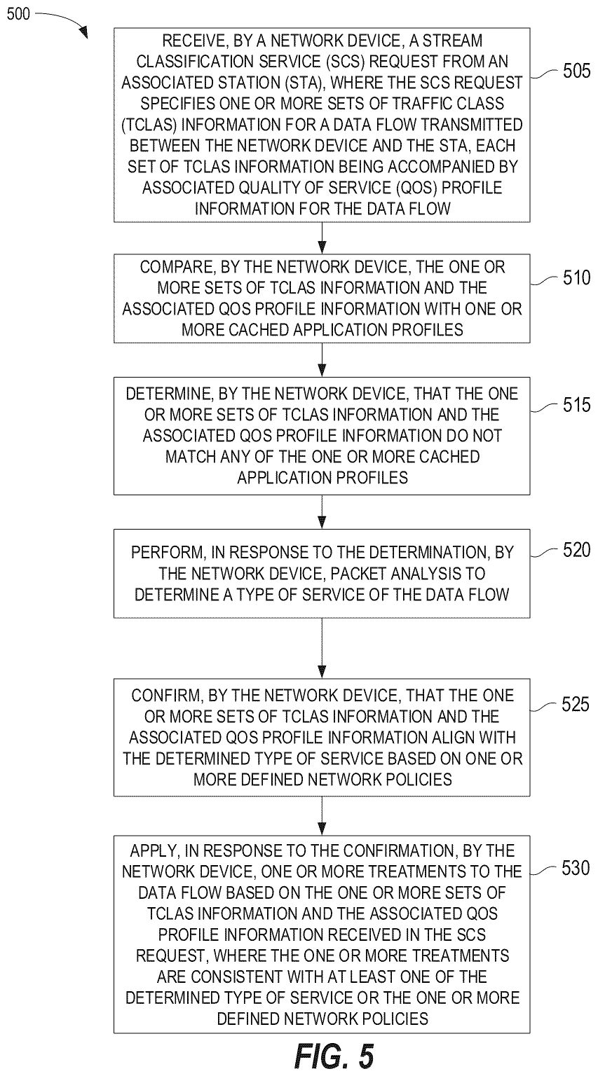

FIG. 5 is a flow diagram depicting an example method 500 for enhanced SCS policy validation, according to some embodiments of the present disclosure.

At block 505, a network device receives a Stream Classification Service (SCS) request from an associated station (STA) (as depicted by step 215 of FIG. 2), where the SCS request specifies one or more sets of traffic class (TCLAS) information for a data flow transmitted between the network device and the STA.

In some embodiments, the one or more sets of TCLAS information may comprise at least one of a 5-tuple or a differentiated services code point (DSCP) value for the data flow, and the 5-tuple may comprise a source IP address, a destination IP address, a source port, a destination port, or a protocol type.

In some embodiments, the associated QoS profile information may comprise one or more QoS characteristics for the data flow, the one or more QoS characteristics comprising at least one of a desired data rate, a delay bound, traffic inter-arrival time, traffic service period, flow start time and a priority level indicated by a traffic identification (TID).

At block 510, the network device compares the one or more sets of TCLAS information and the associated QoS profile information with one or more cached application profiles (as depicted by step 220 of FIG. 2).

At block 515, the network device determines that the one or more sets of TCLAS information and the associated QoS profile information do not match any of the one or more cached application profiles.

At block 520, in response to the determination, the network device performs packet analysis to determine a type of service of the data flow (as depicted by step 245 of FIG. 2).

At block 525, the network device confirms that the one or more sets of TCLAS information and the associated QoS profile information align with the determined type of service based on one or more defined network policies.

At block 530, in response to the confirmation, the network device applies one or more treatments to the data flow based on the one or more sets of TCLAS information and the associated QoS profile information received in the SCS request (as depicted by step 255 of FIG. 2), where the one or more treatments are consistent with at least one of the determined type of service or the one or more defined network policies.

In some embodiments, after determining that the one or more sets of TCLAS information and the associated QoS profile information do not match any of the one or more cached application profiles, the network device may send a first SCS response to the STA, indicating that SCS validation is in processing (as depicted by step 235 of FIG. 2). In some embodiments, the first SCS response may further comprise an indication specifying a time period for which the one or more treatments will be allocated to the STA.

In some embodiments, after confirming that the one or more sets of TCLAS information and the associated QoS profile information align with the determined type of service based on the one or more defined network policies, the network device may send a second SCS response to the STA, confirming the SCS request (as depicted by step 250 of FIG. 2).

In some embodiments, the network device may further define a validation time for the packet analysis based on the one or more network characteristics of the data flow (as depicted by step 235 of FIG. 2).

In some embodiments, to apply the one or more treatments to the data flow, the network device may allocate network resources for the data flow to satisfy one or more of data rate requirements, delay bound requirements, or traffic inter-arrival time and service period requirements of the data flow.

In some embodiments, to apply the one or more treatments to the data flow, the network device may prioritize the data flow in network queues to satisfy one or more priority level requirements of the data flow.

In some embodiments, the network device may receive a second request from the STA (as depicted by step 215 of FIG. 2), where the second SCS request specifies one or more second sets of TCLAS information for a second data flow transmitted between the network device and the STA, each second set of TCLAS information being accompanied by associated QoS profile information. The network device may compare the one or more second sets of TCLAS information and the associated QoS profile information with one or more cached application profiles (as depicted by step 220 of FIG. 2). The network device may determine that the one or more second sets of TCLAS information and the associated QoS profile information match one cached application profile, within the one or more cached application profiles. The network device may apply one or more second treatments to the second data flow that are consistent with the matched profile (as depicted by step 230 of FIG. 2).

In some embodiments, the network device may further send an SCS response to the STA (as depicted by step 225 of FIG. 2), confirming that the one or more second sets of TCLAS information and the associated QoS profile information are received in the second SCS request for the second data flow.

In some embodiments, the network device may receive a second SCS request from the STA (as depicted by step 215 of FIG. 2), wherein the second SCS request specifies one or more second sets of TCLAS information for a second data flow transmitted between the network device and the STA, each second set of TCLAS information being accompanied by associated QoS profile information. The network device may compare the one or more second sets of TCLAS information and the associated QoS profile information with one or more cached application profiles (as depicted by step 220 of FIG. 2). The network device may determine that the one or more second sets of TCLAS information and the associated QoS profile information do not match any of the one or more cached application profiles. The network device may then perform packet analysis to determine the type of service of the second data flow (as depicted by step 240 of FIG. 2). The network device may confirm that the one or more second sets of TCLAS information and the associated QoS profile information do not align with the determined type of service of the second data flow based on the one or more defined network policies.

In some embodiments, after determining that the one or more second sets of TCLAS information and the associated QoS profile information do not match any of the one or more cached application profiles, the network device may send a first SCS response to the STA, indicating that SCS validation is in processing (as depicted by step 235 of FIG. 2). After confirming, by the network device, that the one or more second sets of TCLAS information and the associated QoS profile information do not align with the determined type of service of the second data flow based on the one or more defined network policies, the network device may send a second response to the STA, indicating that the request has been denied (as depicted by step 260 of FIG. 2). The network device may then reclassify the second data flow to a second priority level lower than specified in the one or more second sets of TCLAS and the associated QoS profile information (as depicted by step 265 of FIG. 2). The network device may assign one or more second treatments to the second data flow that are consistent with the second priority level.

In some embodiments, the network device may send a third SCS response to the STA, indicating the second priority level and that the one or more second treatments have been assigned to the second data flow by the network device.

In some embodiments, after determining that the one or more second sets of TCLAS information and the associated QoS profile information do not match any of the one or more cached application profiles, the network device may send a first SCS response to the STA, indicating that SCS validation is in processing (as depicted by step 235 of FIG. 2). After confirming, by the network device, that the one or more second sets of TCLAS information and the associated QoS profile information do not align with the determined type of service of the second data flow based on the one or more defined network policies, the network device may send a second response to the STA, indicating that the request has been denied (as depicted by step 260 of FIG. 2). The network device may then block a transmission of the second data flow to the STA.

In some embodiments, the network device may comprise at least one of an access point (AP), a wireless local area network controller (WLC), a network security appliance, or a gateway, where the network device is integrated with a network policy enforcement function (PEF).

In some embodiments, in response to the SCS request, the network device may apply one or more second treatments to the data flow provisionally for a defined time frame (as depicted by step 320 of FIG. 3), where the one or more second treatments are consistent with the one or more sets of TCLAS information per the one or more defined network policies.

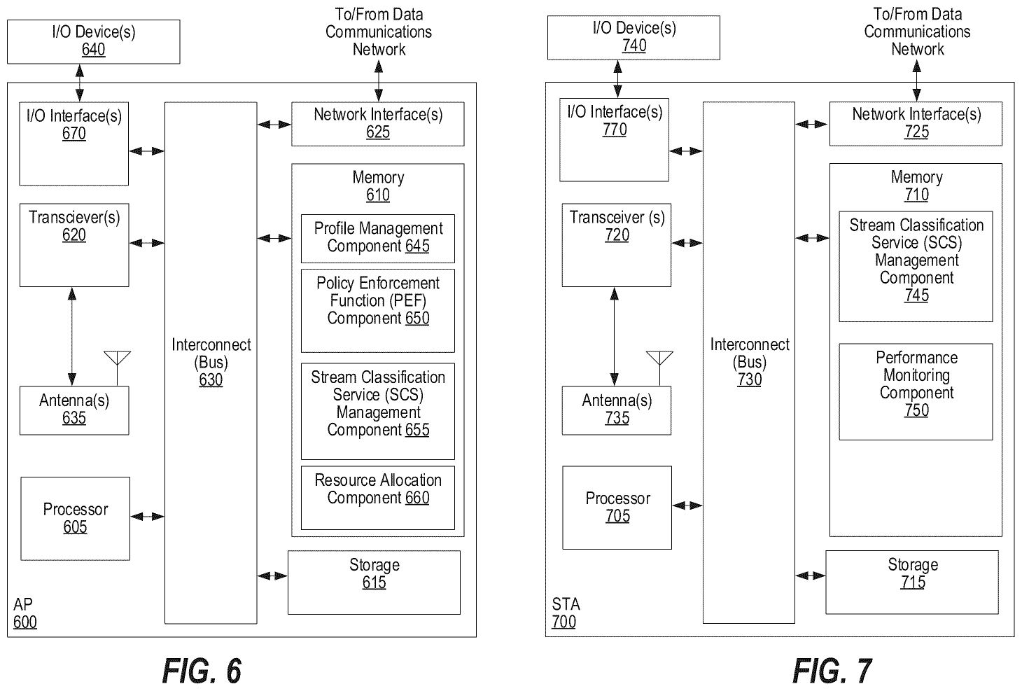

FIG. 6 depicts an example network device 600 configured to perform various aspects of the present disclosure, according to some aspects of the present disclosure. In some embodiments, the example network device 600 may correspond to APs 105 or WLC 155 as depicted in FIG. 1, AP/WLC 205 as depicted in FIG. 2, and AP/WLC 305 as depicted in FIG. 3.

As illustrated, the example network device 600 includes a processor 605, memory 610, storage 615, one or more transceivers 620, one or more I/O interfaces 680, and one or more network interfaces 625. In some embodiments, I/O devices 640 are connected via the I/O interface(s) 680. Further, via the network interface 625, the network device 600 can be communicatively coupled with one or more other devices and components (e.g., via a network, which may include the Internet, local network(s), and the like). Each of the components is communicatively coupled by one or more buses 630. In some embodiments, one or more antennas 635 may be coupled to the transceivers 620 for transmitting and receiving wireless signals.

The processor 605 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 605 processes information received through the transceiver 620, I/O interfaces 680, and the network interfaces 625. The processor 605 retrieves and executes programming instructions stored in memory 610, as well as stores and retrieves application data residing in storage 615.

The storage 615 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 615 may store a variety of data for the efficient functioning of the system.

The memory 610 may include random access memory (RAM) and read-only memory (ROM). The memory 610 may store processor-executable software code containing instructions that, when executed by the processor 605, enable the network device 600 to perform various functions described herein for wireless communication. In the illustrated example, the memory 610 includes four software components: the profile management component 645, the policy enforcement function (PEF) component 650, the stream classification service (SCS) management component 655, and the resource allocation component 660. In some embodiments, the profile management component 645 may be configured to create, update, and manage application profiles. These profiles may contain relevant information about recognized applications, their typical network behaviors, and preferred QoS settings. In some embodiments, the PEF component 650 may handle the policy pre-check and/or on-demand packet analysis. The PEF component 650 may first evaluate incoming UL/DL traffic against cached application profiles to determine its compliance with established standards, and then use analysis techniques like DPI to further inspect traffic that does not initially match known profiles. In some embodiments, the SCS management component 655 may be designed to handle SCS requests and responses. The SCS management component 655 may extract and analyze all incoming SCS requests from STAs. The SCS management component 655 may route the information within these requests to the PEF component 650 for detailed policy checking and packet analysis. Once the analysis is complete, the SCS management component 655 may generate the relevant SCS requests based on findings from the PEF. In some embodiments, the resource allocation component 660 may allocate bandwidth and other network resources among various types of traffic based on priority levels. The resource allocation component 660 may further prioritize different types of traffic in network queues to ensure that time-sensitive services, such as real-time audio and video communications, are delivered with low latency and high reliability.

Although depicted as a discrete component for conceptual clarity, in some embodiments, the operations of the depicted components (and others not illustrated) may be combined or distributed across any number of components. Further, although depicted as software residing in memory 610, in some aspects, the operations of the depicted components (and others not illustrated) may be implemented using hardware, software, or a combination of hardware and software.

FIG. 7 depicts an example client device 700 configured to perform various aspects of the present disclosure, according to some embodiments of the present disclosure. In some embodiments, the example client device 700 may correspond to STAs 110 as depicted in FIG. 1, STA 210 as depicted in FIG. 2, or STA 310 as depicted in FIG. 4.

As illustrated, the example client device 700 includes a processor 705, memory 710, storage 715, one or more transceivers 720, one or more I/O interfaces 780, and one or more network interfaces 725. In some embodiments, I/O devices 740 are connected via the I/O interface(s) 780. Further, via the network interface 725, the client device 700 can be communicatively coupled with one or more other devices and components (e.g., via a network, which may include the Internet, local network(s), and the like). Each of the components is communicatively coupled by one or more buses 730. In some embodiments, one or more antennas 735 may be coupled to the transceivers 720 for transmitting and receiving wireless signals.

The processor 705 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 705 processes information received through the transceiver 720, I/O interfaces 770, and the network interfaces 725. The processor 705 retrieves and executes programming instructions stored in memory 710, as well as stores and retrieves application data residing in storage 715.

The storage 715 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 715 may store a variety of data for the efficient functioning of the system.

The memory 710 may include random access memory (RAM) and read-only memory (ROM). The memory 710 may store processor-executable software code containing instructions that, when executed by the processor 705, enable the client device 700 to perform various functions described herein for wireless communication. In the illustrated example, the memory 710 includes two software components: the SCS management component 745 and the performance monitoring component 750. In some embodiments, the SCS management component 745 may create SCS requests to the AP or WLC based on each application's requirements for QoS. The SCS management component 745 may generate the relevant data, such as the DSCP values and preferred TIDs, 5-tuple data, and other QoS parameters, from the application running on the STA. Additionally, the SCS management component 745 may also analyze the SCS responses from the WLC to determine appropriate actions or adjustments based on the network's feedback. For example, if the SCS response indicates approval of the requested TCLAS (and/or QoS profile) treatments, the SCS management component 745 may adjust QoS settings locally to ensure the traffic is received or transmitted efficiently at the STA level. If the response indicates that certain requests cannot be honored (due to non-alignment with application profiles or policy restrictions), the SCS management component 745 may adapt the STA's network behavior accordingly, such as by adjusting the QoS parameters locally or notifying the user or applications about the changes. In some embodiments, the performance monitoring component 750 may monitor the quality of service received, adjust local settings, and/or report discrepancies to the WLC. The performance monitoring component 750 may track parameters such as latency, packet loss, and jitter to assess the quality of the network connection and provide feedback to the WLC as necessary.

Although depicted as a discrete component for conceptual clarity, in some embodiments, the operations of the depicted components (and others not illustrated) may be combined or distributed across any number of components. Further, although depicted as software residing in memory 710, in some aspects, the operations of the depicted components (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product.

Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
receiving, by a network device, a Stream Classification Service (SCS) request from an associated station (STA), wherein the SCS request specifies one or more sets of traffic class (TCLAS) information for a data flow transmitted between the network device and the STA, each set of TCLAS information being accompanied by associated quality of service (QoS) profile information for the data flow;
comparing, by the network device, the one or more sets of TCLAS information and the associated QoS profile information with one or more cached application profiles;
determining, by the network device, that the one or more sets of TCLAS information and the associated QoS profile information do not match any of the one or more cached application profiles;
performing, in response to the determination, by the network device, packet analysis to determine a type of service of the data flow;
confirming, by the network device, that the one or more sets of TCLAS information and the associated QoS profile information align with the determined type of service based on one or more defined network policies; and
applying, in response to the confirmation, by the network device, one or more treatments to the data flow based on the one or more sets of TCLAS information and the associated QoS profile information received in the SCS request, wherein the one or more treatments are consistent with at least one of the determined type of service or the one or more defined network policies.

2. The method of claim 1, further comprising:
after determining that the one or more sets of TCLAS information and the associated QoS profile information do not match any of the one or more cached application profiles, sending, by the network device to the STA, a first SCS response indicating that SCS validation is in processing; and
after confirming that the one or more sets of TCLAS information and the associated QoS profile information align with the determined type of service based on the one or more defined network policies, sending, by the network device to the STA, a second SCS response confirming the SCS request.

3. The method of claim 1, wherein the associated QoS profile information comprises one or more QoS characteristics for the data flow, the one or more QoS characteristics comprising at least one of a desired data rate, a delay bound, traffic inter-arrival time, traffic service period, flow start time and a priority level indicated by a traffic identification (TID).

4. The method of claim 1, wherein the one or more sets of TCLAS information comprises at least one of a 5-tuple or a differentiated services code point (DSCP) value for the data flow, the 5-tuple comprising a source IP address, a destination IP address, a source port, a destination port, or a protocol type.

5. The method of claim 3, further comprising defining, by the network devices, a validation time for the packet analysis based on the one or more QoS characteristics of the data flow.

6. The method of claim 1, wherein applying the one or more treatments to the data flow comprises allocating, by the network device, network resources for the data flow to satisfy one or more of data rate requirements, delay bound requirements, or traffic inter-arrival time and service period requirements of the data flow.

7. The method of claim 1, wherein applying the one or more treatments to the data flow comprises prioritizing, by the network device, the data flow in network queues to satisfy one or more priority level requirements of the data flow.

8. The method of claim 2, wherein the first SCS response further comprises an indication specifying a time period for which the one or more treatments will be allocated to the STA.

9. The method of claim 1, further comprising:
receiving, by the network device, a second SCS request from the STA, wherein the second SCS request specifies one or more second sets of TCLAS information for a second data flow transmitted between the network device and the STA, each second set of TCLAS information being accompanied by associated QoS profile information;
comparing, by the network device, the one or more second sets of TCLAS information and the associated QoS profile information with one or more cached application profiles;
determining that the one or more second sets of TCLAS information and the associated QoS profile information match one cached application profile, within the one or more cached application profiles; and
applying, by the network device, one or more second treatments to the second data flow that are consistent with the matched profile.

10. The method of claim 9, further comprising sending, by the network device to the STA, an SCS response confirming that the one or more second sets of TCLAS information and the associated QoS profile information are received in the second SCS request for the second data flow.

11. The method of claim 1, further comprising:
receiving, by the network device, a second SCS request from the STA, wherein the second SCS request specifies one or more second sets of TCLAS information for a second data flow transmitted between the network device and the STA, each second set of TCLAS information being accompanied by associated QoS profile information;
comparing, by the network device, the one or more second sets of TCLAS information and the associated QoS profile information with one or more cached application profiles;
determining that the one or more second sets of TCLAS information and the associated QoS profile information do not match any of the one or more cached application profiles;
performing, in response to the determination, by the network device, packet analysis to determine a type of service of the second data flow; and
confirming, by the network device, that the one or more second sets of TCLAS information and the associated QoS profile information do not align with the determined type of service of the second data flow based on the one or more defined network policies.

12. The method of claim 11, further comprising:
after determining that the one or more second sets of TCLAS information and the associated QoS profile information do not match any of the one or more cached application profiles, sending, by the network device to the STA, a first SCS response indicating that SCS validation is in processing;
after confirming, by the network device, that the one or more second sets of TCLAS information and the associated QoS profile information do not align with the determined type of service of the second data flow based on the one or more defined network policies, sending, by the network device to the STA, a second SCS response indicating that the second SCS request has been denied;
reclassifying, by the network device, the second data flow to a second priority level lower than specified in the one or more second sets of TCLAS and the associated QoS profile information; and
assigning, by the network device, one or more second treatments to the second data flow that are consistent with the second priority level.

13. The method of claim 12, further comprising sending, by the network device to the STA, a third SCS response indicating the second priority level and that the one or more second treatments have been assigned to the second data flow by the network device.

14. The method of claim 11, further comprising:
after determining that the one or more second sets of TCLAS information and the associated QoS profile information do not match any of the one or more cached application profiles, sending, by the network device to the STA, a first SCS response indicating that SCS validation is in processing;
after confirming, by the network device, that the one or more second sets of TCLAS information and the associated QoS profile information do not align with the determined type of service of the second data flow based on the one or more defined network policies, sending, by the network device, a second SCS response to the STA, indicating that the second SCS request has been denied; and
blocking, by the network device, a transmission of the second data flow to the STA.

15. The method of claim 1, wherein the network device comprises at least one of an access point (AP), a wireless local area network controller (WLC), a network security appliance, or a gateway, and wherein the network device is integrated with a network policy enforcement function (PEF).

16. The method of claim 1, further comprising, in response to the SCS request, applying, by the network device, one or more second treatments to the data flow provisionally for a defined time frame, wherein the one or more second treatments are consistent with the one or more sets of TCLAS information per the one or more defined network policies.

17. A system of a network device, comprising:
one or more computer processors; and
one or more memories collectively containing one or more programs, which, when executed by the one or more computer processors, perform operations, the operations comprising:
receiving, by a network device, a Stream Classification Service (SCS) request from an associated station (STA), wherein the SCS request specifies one or more sets of traffic class (TCLAS) information for a data flow transmitted between the network device and the STA, each set of TCLAS information being accompanied by associated quality of service (QoS) profile information for the data flow;
comparing the one or more sets of TCLAS information and the associated QoS profile information with one or more cached application profiles;
determining that the one or more sets of TCLAS information and the associated QoS profile information do not match any of the one or more cached application profiles;
performing packet analysis to determine a type of service of the data flow;
confirming that the one or more sets of TCLAS information and the associated QoS profile information align with the determined type of service based on one or more defined network policies; and
applying, in response to the confirmation, one or more treatments to the data flow based on the one or more sets of TCLAS information and the associated QoS profile information received in the SCS request, wherein the one or more treatments are consistent with at least one of the determined type of service or the one or more defined network policies.

18. The system of claim 17, wherein the one or more programs, which, when executed by the one or more computer processors, perform the operations further comprising:
after determining that the one or more sets of TCLAS information and the associated QoS profile information do not match any of the one or more cached application profiles, sending, by the network device to the STA, a first SCS response indicating that SCS validation is in processing; and
after confirming that the one or more sets of TCLAS information and the associated QoS profile information align with the determined type of service based on the one or more defined network policies, sending, by the network device to the STA, a second SCS response confirming the SCS request.

19. The system of claim 17, wherein the one or more sets of TCLAS information comprises at least one of a 5-tuple or a differentiated services code point (DSCP) value for the data flow, the 5-tuple comprising a source IP address, a destination IP address, a source port, a destination port, or a protocol type.

20. One or more non-transitory computer-readable media containing, in any combination, computer program code that, when executed by operation of a computer system, performs operations comprising:
receiving, by a network device, a Stream Classification Service (SCS) request from an associated station (STA), wherein the SCS request specifies one or more sets of traffic class (TCLAS) information for a data flow transmitted between the network device and the STA, each set of TCLAS information being accompanied by associated quality of service (QoS) profile information for the data flow;
comparing, by the network device, the one or more sets of TCLAS information and the associated QoS profile information with one or more cached application profiles;
determining, by the network device, that the one or more sets of TCLAS information and the associated QoS profile information do not match any of the one or more cached application profiles;
performing, by the network device, packet analysis to determine a type of service of the data flow;
confirming, by the network device, that the one or more sets of TCLAS information and the associated QoS profile information align with the determined type of service based on one or more defined network policies; and
applying, in response to the confirmation, by the network device, one or more treatments to the data flow based on the one or more sets of TCLAS information and the associated QoS profile information received in the SCS request, wherein the one or more treatments are consistent with at least one of the determined type of service or the one or more defined network policies.
